(19) United States
(12) Patent Application Publication
(10) Pub. No.: US 2021/0044096 A1
(43) Pub. Date: Feb. 11, 2021

(54) ELECTRICAL MODULE JUNCTION BOX TRANSFER DEVICE (E-JBTD) SYSTEM HAVING ELECTRICAL ENERGY INTERNAL AND EXTERNAL CONNECTIONS

(71) Applicant: SolarWindow Technologies, Inc., Vestal, NY (US)

(72) Inventors: John A. CONKLIN, Apalachin, NY (US); Patrick T. SARGENT, Canton, GA (US)

(73) Assignee: SolarWindow Technologies, Inc., Vestal, NY (US)

(21) Appl. No.: 16/885,807

(22) Filed: May 28, 2020

Related U.S. Application Data
(60) Provisional application No. 62/854,276, filed on May 29, 2019.

(51) Int. Cl. H02G 3/08; H02S 40/34; H05K 7/02

(52) U.S. Cl. CPC H02G 3/08; H05K 7/026; H02S 40/34

(57) ABSTRACT

An Electrical Module Junction Box Transfer Device (E-JBTD) includes one or more electrical connectors, and a non-conductive dielectric insulating material protecting the one or more electrical connectors. A system includes an electricity-generating glass (EGP) device, and an Electrical Junction Box Electron Transfer Device (E-JBTD) on the electricity-generating glass (EGP) device. The Electrical Module Junction Box Transfer Device (E-JBTD) is water and weather tight, maintains a secure electrical connection between modules or electricity-generating glass (EGP) devices, and may not be removed after installation and reinstalled on another module or electricity-generating glass (EGP) device.

### CROSS-REFERENCE TO RELATED APPLICATIONS

This application claims priority under 35 U.S.C. 119(e) of U.S. Provisional Application No. 62/854,276, filed on May 29, 2019, (Attorney Docket No. 7006/0189PR01), the entire contents of which are hereby incorporated by reference and for which priority is claimed under 35 U.S.C. § 120.

### BACKGROUND

A conventional electrical wiring connection system may include a wiring system and components (electrical energy hardware, wire and terminal contacts, connections, etc.) to transfer electrical energy from a device (such as an electricity-generating glass or flexible substrate product(s) (EGPs)) to wires for use. These connections commonly must rely on electrical wiring connections, adding connectors, and installation of junction boxes at discrete points of contact or connection, and electrical testing.

### SUMMARY OF THE INVENTION

The present invention recognizes that the discrete points of contact or connection in conventional electrical wiring connection systems present challenges for the installation of electricity-generating glass (EGP) devices that have limited or constrained access by space or location. The present invention also recognizes that current mounting systems present a challenge in safely securing electricity-generating glass (EGP) devices to vertical surface of structures, while at the same time allowing for easy non-impinged wiring configurations.

In the conventional art, the installation of an electrical energy junction box (J-Box) device may be compromised or prohibited by difficult, if not impossible, installations due to space, fixture, building and mounting unit constraints that do not allow proper or secure electrical connection. The conventional art is also mounted to the back of drilled glass, which provides weak and possible points of fracture, locations for moisture ingress causing failed electrical connections or electrical shorts, and flawed aesthetics and imperfections.

The present invention recognizes that there is a need for this art in the industry for replacing conventional J-Box electrical wiring connections with an improved and simplified internal- and external-connection system for collecting the electrical energy produced by electricity-generating glass (EGP) devices. To solve these and other related electrical connection issues, the present invention provides a novel internal Electrical Module Junction Box Transfer Device (E-JBTD) that reduces costs, improves safety and electrical connectivity, and improves and simplifies installation processes, thereby providing important advantages for electrical connections for electricity-generating glass (EGP) devices required by glass and window fabricators, and glass installers (i.e., glaziers), photovoltaic (PV) installers, electricians, and maintenance personnel.

The present invention further provides a novel internal Electrical Module Junction Box Transfer Device (E-JBTD) that allows electricity-generating glass (EGP) devices to maintain connection tightness, structural integrity, function, and purpose of a module, laminated veneer, spandrel, etc., and all other glass fabricated products, to function as designed and fabricated while allowing effective electricity transfer from the electricity-generating surface(s) or coatings of the electricity-generating glass devices (EGP) devices to the internal and external elements of the Electrical Module Junction Box Transfer Device (E-JBTD). The exemplary embodiments of the invention allow for maximum electricity transfer using electricity-generating glass (EGP) devices inner connections, while at the same time maintaining all of the performance properties regarding photon transfer, electricity and power generation, and aesthetic value or properties.

The present invention further recognizes that the combining of electricity-generating glass (EGP) devices and an exemplary Electrical Module Junction Box Transfer Device (E-JBTD) will allow productive, efficient, and effective electricity transfer from the device for use. According to example embodiments of the invention, an Electrical Module Junction Box Transfer Device (E-JBTD) can be configured as an integral part of any electricity-generating glass (EGP) or electricity-generating glass (EGP) device module. It is desirable, and in some cases critical, that electron transfer from the electrical coating and/or connections on the inside of the electricity-generating glass (EGP) devices be safely, efficiently, and/or effectively interconnected to the external frame mounted wiring systems for electricity transfer.

The present invention is not limited to any particular electricity-generating glass (EGP) device and can include, for example, various laminated roof modules, laminated veneer, spandrel, creative glass, textured glass, security glass, etc., among other glass products.

The Electrical Module Junction Box Transfer Device (E-JBTD) may be integrated into a glass product, such as into and on the edge of a sealed edge glass product. The Electrical Module Junction Box Transfer Device (E-JBTD) can include engagement devices at opposite electrical series or parallel string terminal connections configured to maximize voltage and current for effective power levels needed for proper connection to other balance of systems (BOS) components.

The Electrical Module Junction Box Transfer Device (E-JBTD) can be integrated into a typical double lite laminated glass product. In some examples, the Electrical Module Junction Box Transfer Device (E-JBTD) can include one or more rigidly mounted in place electrical connector(s), which are physically separated by a non-conductive dielectric insulating material protecting and insulating the electrical contacts. The interconnection between the module and Electrical Module Junction Box Transfer Device (E-JBTD) is novel in inception, and the completion of the connection is utilized by pressing the Electrical Module Junction Box Transfer Device (E-JBTD) on to the existing module electrical tabs and firmly seating the Electrical Module Junction Box Transfer Device (E-JBTD) on the edge of the electricity-generating glass (EGP) devices or electricity-generating glass (EGP) module. The internal electrical connections are then translated to typical MC-4 connections, as shown in FIG. 1. The MC-4 connections are single-contact electrical connectors commonly used for connecting solar panels and the typical industry standard with regard to module-to-module, or module-to-balance of systems (BOS) terminal wire connections.

An exemplary embodiment of the invention is directed to an Electrical Junction Box Electron Transfer Device (E-JBTD) including one or more electrical connectors, and a non-conductive dielectric insulating material protecting the one or more electrical connectors. The Electrical Junction Box Electron Transfer Device (E-JBTD) can include one or more single-contact electrical connectors electrically connected to the one or more electrical connectors. The one or more single-contact electrical connectors can include MC-4 connections.

Another exemplary embodiment of the invention is directed to a system including an electricity-generating glass (EGP) device, and an Electrical Junction Box Electron Transfer Device (E-JBTD) on the electricity-generating glass (EGP) device. The Electrical Module Junction Box Transfer Device (E-JBTD) can be integrated into an edge of the electricity-generating glass (EGP) device.

Other features and advantages of the present invention will become apparent to those skilled in the art upon review of the following detailed description and drawings.

### BRIEF DESCRIPTION OF THE DRAWINGS

These and other aspects and features embodiments of the present invention will be better understood after reading the following detailed description, together with the attached drawings, contained herein:

FIG. 1 illustrates an example of a conventional male and female MC-4 connector of a photovoltaic (PV) module;

FIG. 2A illustrates a schematic front view of an Electrical Module Junction Box Transfer Device (E-JBTD) according to an exemplary embodiment of the invention;

FIG. 2B illustrates a schematic bottom view of an Electrical Module Junction Box Transfer Device (E-JBTD) according to an exemplary embodiment of the invention;

FIG. 2C illustrates a schematic top view of an Electrical Module Junction Box Transfer Device (E-JBTD) according to an exemplary embodiment of the invention;

FIG. 3A illustrates a schematic left side view of an Electrical Module Junction Box Transfer Device (E-JBTD) connected with an electricity-generating glass (EGP) according to an exemplary embodiment of the invention;

FIG. 3B illustrates a schematic right side view of an Electrical Module Junction Box Transfer Device (E-JBTD) connected with an electricity-generating glass (EGP) according to an exemplary embodiment of the invention;

FIG. 3C illustrates a schematic partial view of a portion of the Electrical Module Junction Box Transfer Device (E-JBTD) connected with an electricity-generating glass (EGP) of FIG. 3A, viewed along Section C3-C3 of FIG. 4A;

FIG. 4A illustrates a schematic top view of a system including an Electrical Module Junction Box Transfer Device (E-JBTD) connected with an electricity-generating glass (EGP) according to an exemplary embodiment of the invention; and

FIG. 4B illustrates a schematic exploded view of a system including an Electrical Module Junction Box Transfer Device (E-JBTD) configured to be connected with an electricity-generating glass (EGP) according to an exemplary embodiment of the invention.

### DETAILED DESCRIPTION OF THE EXEMPLARY EMBODIMENTS OF THE INVENTION

The present invention now is described more fully hereinafter with reference to the accompanying drawings, in which embodiments of the invention are shown. This invention, however, may be embodied in many different forms and should not be construed as limited to the embodiments set forth herein; rather, these embodiments are provided so that this disclosure will be thorough and complete, and will fully convey the scope of the invention to those skilled in the art.

Referring now to the drawings, exemplary embodiments of an Electrical Module Junction Box Transfer Device (E-JBTD).

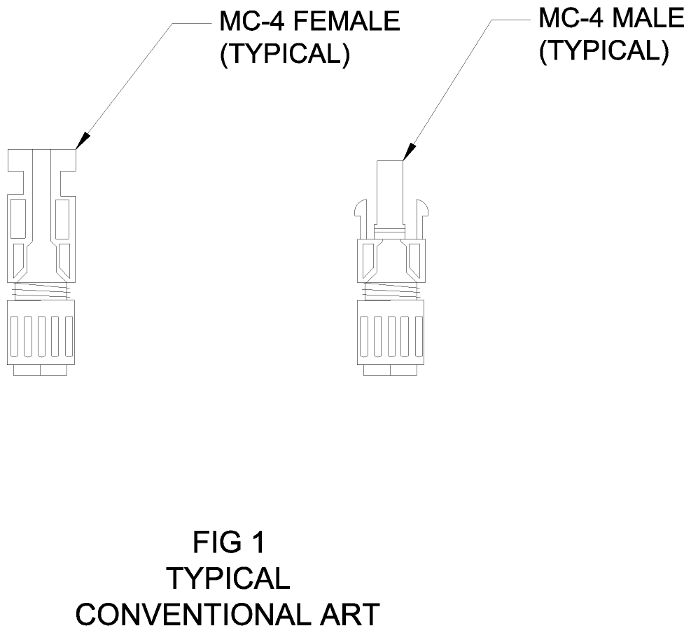

FIG. 1 illustrates an example of a conventional MC-4 connector that is configured to fasten and connect an electricity-generating glass (EGP) device outside rated insulated conductor to a module or other device.

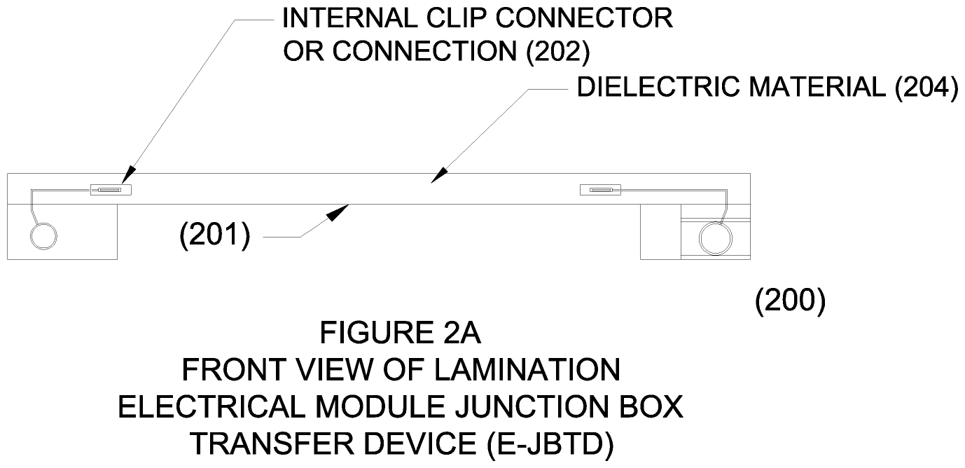

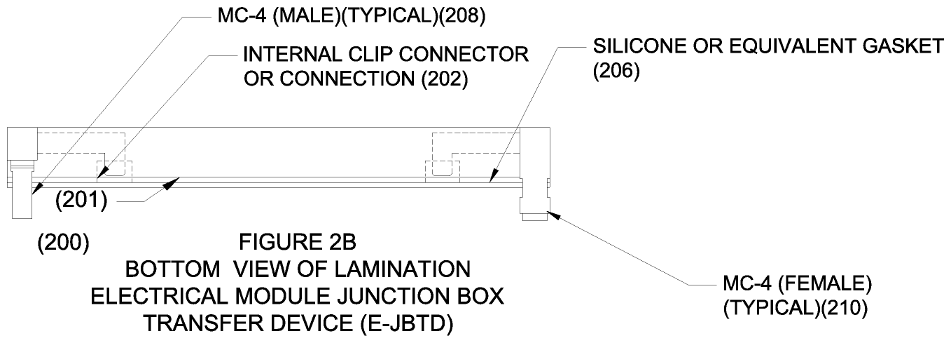

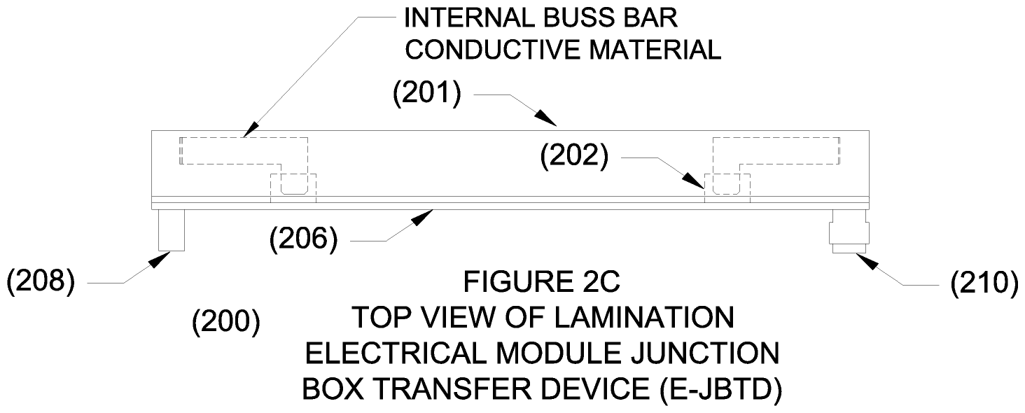

FIGS. 2A-4B illustrate exemplary embodiments of an Electrical Module Junction Box Transfer Device (E-JBTD) 200 according to the invention.

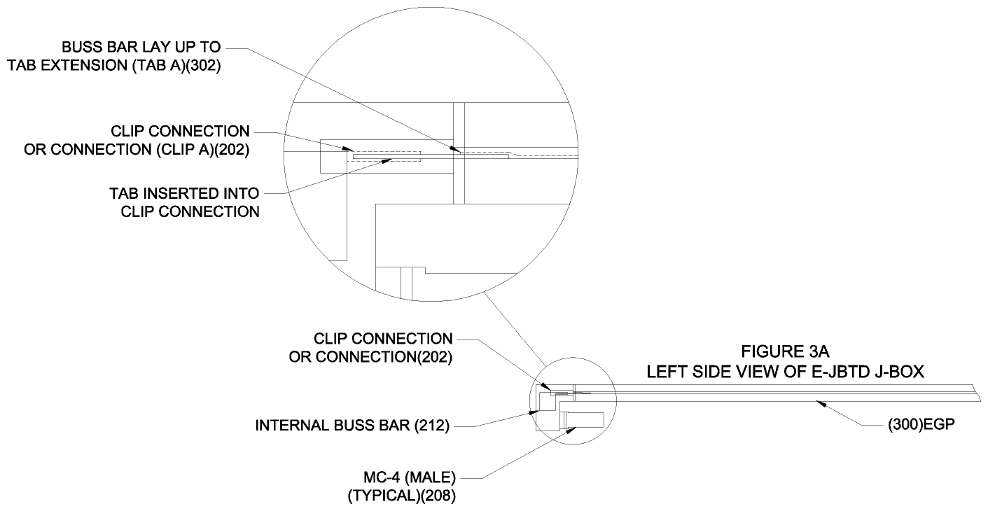

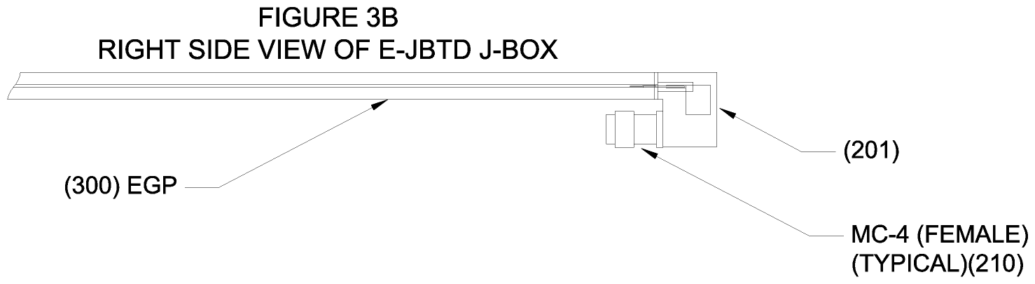

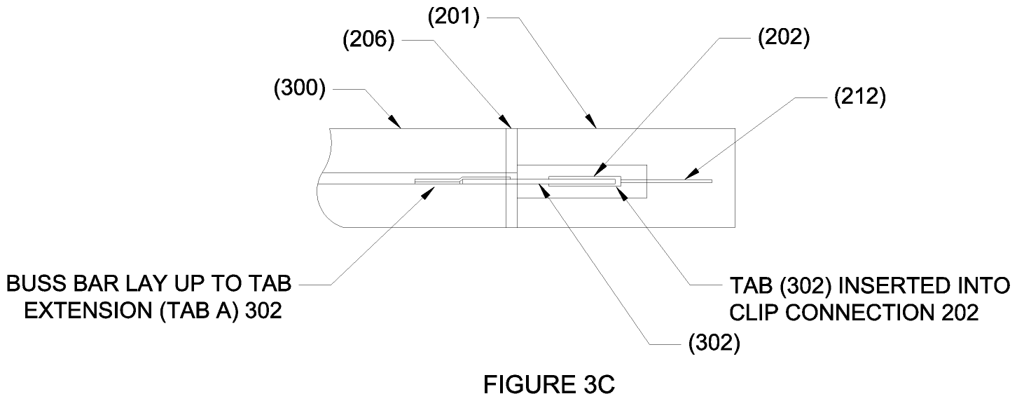

Particularly, FIGS. 2A-2C illustrate a front, bottom and top view of an example of an Electrical Module Junction Box Transfer Device (E-JBTD) 200. As shown in the front view (FIG. 2A) of the Electrical Module Junction Box Transfer Device (E-JBTD) 200, the Electrical Module Junction Box Transfer Device (E-JBTD) 200 having a body 201 including internal connection clips 202 (e.g., electron transfer clips; CLIP A 202 in FIGS. 3A, 3C) that are designed to be pressed on to the electrical tabs (e.g., TAB A 302 in FIGS. 3A, 3C) emerging from the front leading edge of the electricity-generating glass (EGP) 300. Theses electron transfer clips (CLIP A 202) are connected internally within the body 201 to the outside integrated MC-4 connectors 208, 210 that will allow for seamless connection to the universally used electrical connectors (e.g., electrical connectors commonly used for connecting solar panels in compliance with typical industry standards with regard to module to module, or module to balance of systems (BOS) terminal wire connections). The Electrical Module Junction Box Transfer Device (E-JBTD) 200 is designed with a non-conductive dielectric insulating material 204 that isolates the electrical contact points between the positive and negative conductor terminals to prevent arcing. For example, the non-conductive dielectric insulating material 204 can be a separate component provided to isolate the electrical contact points between the positive and negative conductor terminals to prevent arcing, or the non-conductive dielectric insulating material 204 can be integrally formed with the body 201, or a portion thereof, to isolate the electrical contact points between the positive and negative conductor terminals to prevent arcing. In an example, a leading edge of the body 201 of the Electrical Module Junction Box Transfer Device (E-JBTD) 200 can be capped with an insulating silicone material 206, or the like, allowing for a liquid-tight connection. Additionally, the bottom view (FIG. 2B) also shows details of the non-conductive dielectric insulating material 204 protecting the electrical contact, as well as the bottom connected universally used connection points. The top view (FIG. 2C) of the Electrical Module Junction Box Transfer Device (E-JBTD) 200 details an example in which the electrical conductor points of contact are completely encased in non-conductive dielectric insulating material 204. Also, the top view details an example of an internal buss bar 212, or the like, that is encapsulated with a non-convective dielectric material 204 and runs from the internal clip 202 to the output wire connections (e.g., 208, 210). The MC-4 male 208 and female 210 connections are connections typically used to secure the output of positive and negative conductor terminal connections. In industry, the female connection 210 is typically positive (+) and the male connection 208 is typically negative (−). This plug and socket connection is designed to prevent accidental conductor connections.

FIGS. 3A-3C illustrate exemplary left- and right-side views of an Electrical Module Junction Box Transfer Device (E-JBTD) 200 as it fits onto a laminated electricity-generating glass (EGP) device or module 300. FIGS. 3A-3C illustrate examples of both the left and right-side views and how the electrical tab 302 extending from the EGP device/module 300 connects seamlessly to the electrical connector clip 202 of the Electrical Module Junction Box Transfer Device (E-JBTD) 200. Also, FIGS. 3A-3C illustrate examples including a silicone insulating, water tight seal 206 that fits between the Electrical Module Junction Box Transfer Device (E-JBTD) 200 and the glass/glass laminate of the EGP device/module 300 (e.g., between the body 201, or a portion thereof, of the E-JBTD 200 and the glass/glass laminate of the EGP device/module 300).

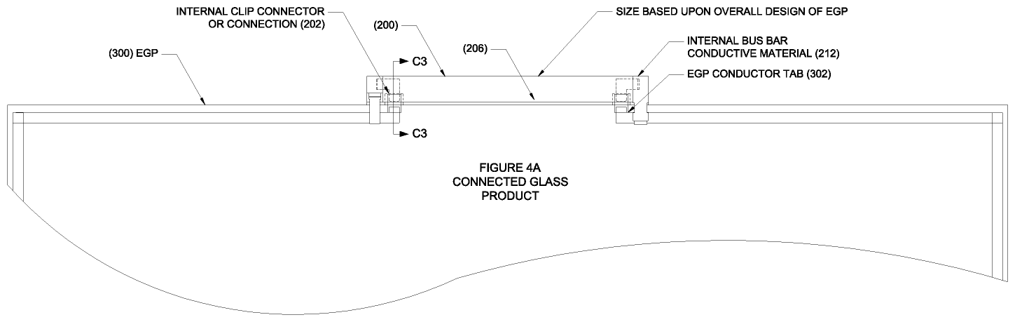

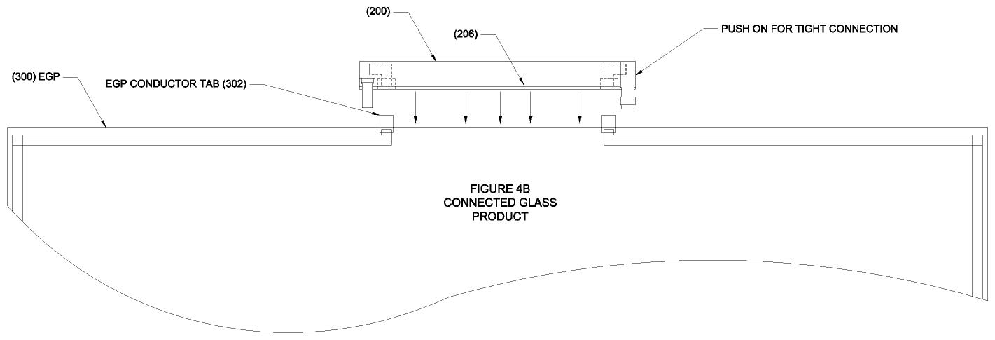

FIGS. 4A-4B illustrate top down views with and without the Electrical Module Junction Box Transfer Device (E-JBTD) connected. FIG. 4A illustrates an example of a fully connected Electrical Module Junction Box Transfer Device (E-JBTD) 200 on an EGP device/module 300 and how the size of the Electrical Module Junction Box Transfer Device (E-JBTD) 200 can be configured to be aligned to a size of the EGP device/module 300. In the illustrated examples, a size of the Electrical Module Junction Box Transfer Device (E-JBTD) 200 is based upon the vertical mounting of the typical art used today for mounting solar photovoltaic (PV) panels. The size, however, is not limited to the size shown in this example, and other examples can be configured differently with different sizing. For example, a size of the Electrical Module Junction Box Transfer Device (E-JBTD) 200 can be reduced or enlarged based upon the design of the panel or electricity-generating glass (EGP) device/module 300. FIG. 4B illustrates an example in which the fixture connection of the Electrical Module Junction Box Transfer Device (E-JBTD) 200 can be configured to be secured with one click (i.e., a single click connection) to the EGP device/module 300. The Electrical Module Junction Box Transfer Device (E-JBTD) 200 can be configured to be easily applied to the module or electricity-generating glass (EGP) device 300 allowing for a safe and secure connection. In an example, once a connection between the Electrical Module Junction Box Transfer Device (E-JBTD) 200 is made with the electricity-generating glass (EGP) device 300, it is not to be removed, and reinstalled on another module or electricity-generating glass (EGP) device. In some examples, the Electrical Module Junction Box Transfer Device (E-JBTD) 200 can be such that it is not reusable, and is not intended to be removed (e.g., not capable of being removed) once installed at the factory.

The present invention has been described herein in terms of several preferred embodiments. However, modifications and additions to these embodiments will become apparent to those of ordinary skill in the art upon a reading of the foregoing description. It is intended that all such modifications and additions comprise a part of the present invention to the extent that they fall within the scope of the several claims appended hereto.

What is claimed is:

1. An Electrical Junction Box Electron Transfer Device (E-JBTD) comprising:
a body;
one or more electrical connectors on the body; and
a non-conductive dielectric insulating material protecting the one or more electrical connectors.

2. The Electrical Module Junction Box Transfer Device (E-JBTD) of claim 1, wherein the one or more electrical connectors includes at least two electrical connectors, and
wherein the non-conductive dielectric insulating material physically separates the at least two electrical conductor connectors.

3. The Electrical Module Junction Box Transfer Device (E-JBTD) of claim 1, further comprising:
one or more single-contact electrical conductor connectors electrically connected to the one or more electrical connectors.

4. The Electrical Module Junction Box Transfer Device (E-JBTD) of claim 3, wherein the one or more single-contact electrical connectors includes an MC-4 connection.

5. The Electrical Module Junction Box Transfer Device (E-JBTD) of claim 1, further comprising:
at least two single-contact electrical connectors electrically connected to the at least two electrical connectors.

6. The Electrical Module Junction Box Transfer Device (E-JBTD) of claim 5, wherein the at least two single-contact electrical connectors include MC-4 connections.

7. The electrical junction box electron transfer device Electrical Module Junction Box Transfer Device (E-JBTD) of claim 6, wherein one of the MC-4 connections includes a male MC-4 connection and another of the MC-4 connections includes a female MC-4 connection.

8. The Electrical Module Junction Box Transfer Device (E-JBTD) of claim 1, wherein an edge of the body is capped with an insulating material that is configured to provide a liquid-tight connection to a module or electricity-generating glass (EGP) device.

9. The Electrical Module Junction Box Transfer Device (E-JBTD) of claim 1, wherein the one or more electrical connectors are completely isolated from each other by the non-conductive dielectric insulating material.

10. The Electrical Module Junction Box Transfer Device (E-JBTD) of claim 1, further comprising:
an internal buss bar encapsulated with the non-conductive dielectric insulating material.

11. The Electrical Module Junction Box Transfer Device (E-JBTD) of claim 3, further comprising:
an internal buss bar electrically connecting the one or more single-contact electrical connectors to the one or more electrical connectors and encapsulated within the non-conductive dielectric insulating material.

12. A system comprising:
an electricity-generating glass (EGP) device; and
the Electrical Module Junction Box Transfer Device (E-JBTD) of claim 1 on the electricity-generating glass (EGP) device.

13. The system of claim 12, wherein the Electrical Module Junction Box Transfer Device (E-JBTD) is integrated into an edge of the electricity-generating glass (EGP) device.

14. The system of claim 13, further comprising:
an insulating material between the electricity-generating glass (EGP) device and the Electrical Module Junction Box Transfer Device (E-JBTD) and configured to provide a liquid-tight connection between the electricity-generating glass (EGP) device and the Electrical Module Junction Box Transfer Device (E-JBTD).

15. The system of claim 12, wherein the electricity-generating glass (EGP) includes one or more electrical tabs, and
wherein the one or more electrical connectors of the Electrical Module Junction Box Transfer Device (E-JBTD) are configured to be respectively coupled to the one or more electrical tabs of the electricity-generating glass (EGP).

16. The system of claim 15, wherein the one or more electrical connectors are configured to be respectively press fit on the one or more electrical tabs.

17. The system of claim 12, wherein the Electrical Module Junction Box Transfer Device (E-JBTD) is configured to be connected to the electricity-generating glass (EGP) device such that the Electrical Module Junction Box Transfer Device (E-JBTD) is not removable from the electricity-generating glass (EGP) device once connected.

18. The system of claim 12, wherein the Electrical Module Junction Box Transfer Device (E-JBTD) is configured to be connected to the electricity-generating glass (EGP) device such that, once connected, the Electrical Module Junction Box Transfer Device (E-JBTD) is not reusable on another electricity-generating glass (EGP) device.
